(19) United States
(12) Patent Application Publication
(10) Pub. No.: US 2010/0116362 A1
(43) Pub. Date: May 13, 2010

(54) PASSIVE CONTROL VALVE

(75) Inventors: Paulus Cornelis Duineveld, Eindhoven (NL); Klaas Kooijker, Eindhoven (NL); Marie Sybien Nijboer, Eindhoven (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/993,754

(22) PCT Filed: Jun. 30, 2006
(86) PCT No.: PCT/IB2006/052213

§ 371 Date: Dec. 29, 2009

Related U.S. Application Data
(60) Provisional application No. 60/695,658, filed on Jun. 30, 2005.

(51) Int. Cl. F16K 17/00

(52) U.S. Cl. 137/467.5

(57) ABSTRACT

The control valve for release of gas from a pressurized vessel is a rubber valve with an opening therethrough, the rubber having such a Shore hardness and the valve having such a configuration relative to the size of the opening and the pressure of the gas in the vessel, that the mass flow of gas from the vessel is approximately constant as the gas exits from the vessel.

This invention relates generally to valves to control the release of gas from a pressurized vessel such as for use in a liquid droplet generation and delivery system, and more specifically concerns such a control valve which is passive in operation.

Pressurized vessels containing gas, such as air, are known for use in various applications. One example is for accelerating liquid droplets, such as a dentifrice or water droplets, used in a teeth cleaning system. In such an application, and similar applications involving the acceleration of liquid droplets, it is important that the mass flow of the gas from the pressurized vessel remain sufficiently constant over a selected period of time, typically during the entire time that the valve is open, from the vessel being full to the vessel being empty.

Heretofore, control valves to provide constant mass flow have been active rather than passive in operation. In an active valve, the exit area of the valve increases by means of a control circuit/assembly as a function of time, compensating for the reduced pressure of the gas as the vessel empties. It is possible to calculate mathematically the function which will accomplish this result. However, the control circuit/structure to carry out the function is complex; such a valve is expensive and will often be unreliable in use.

Hence, it would be desirable to have a simple, preferably passive, control valve to produce a constant mass flow rate from a pressurized vessel as it goes from full capacity to empty.

Accordingly, the present invention is a passive control valve for use with a pressurized gas vessel, comprising: a control valve for controlling the release of gas from a pressurized vessel, the released gas then being used to accelerate liquid droplets, wherein the control valve comprises a rubberized material having an opening therethrough, allowing gas to escape in a controlled manner from the pressurized vessel, wherein the rubberized material has such a Shore hardness value and wherein the valve has such a configuration, relative to the size of the opening therethrough the valve and the pressure of the gas in the vessel, that the mass flow of gas from the vessel is approximately constant over time as gas exits from the vessel.

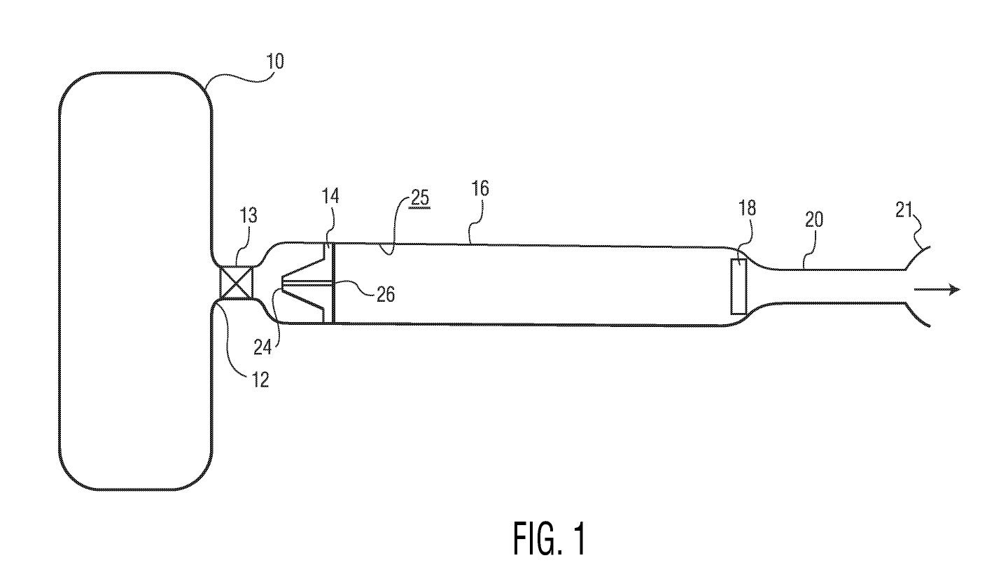

FIG. 1 is a simple cross-sectional view showing the combination of a pressurized vessel, a control valve and a droplet generation system.

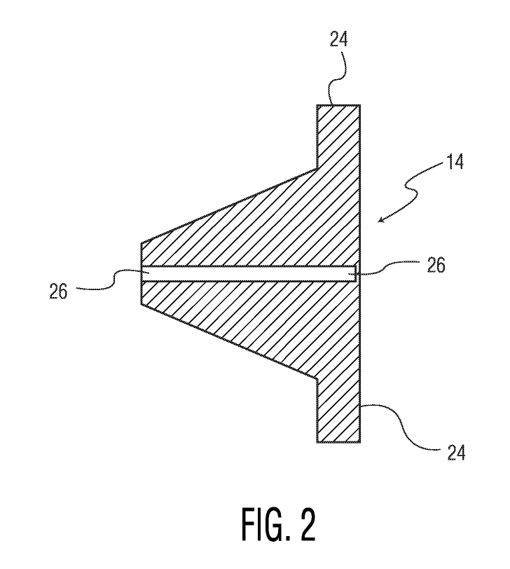

FIG. 2 is a cross-sectional view showing in more detail the embodiment of the control valve described herein.

In general, the present invention is a passive control valve 14 which in operation releases gas from a pressurized vessel with a mass flow rate which remains constant over a selected period of use, such as from the time that the release of gas begins until the gas is all released. The valve has an opening 26 which permits the release of gas. The valve itself is so constructed and arranged and comprises such a material that the area of the opening through the valve 14 is an inverse function of the reservoir pressure, i.e. as the pressure decreases, the cross-sectional area of the opening 26 increases.

Such a valve is useful in a variety of applications. One such application is a liquid droplet generation system, with the gas exiting from the control valve being used to accelerate liquid droplets to a desired high velocity. One example of the use of liquid droplets is for cleansing teeth, in which individual droplets of water or liquid dentifrice of a selected size are accelerated to a desired velocity and directed toward a user's teeth for cleansing thereof. Such a droplet system is shown and described in co pending application Ser. No. 60/537,690, filed on Jan. 20, 2004, which is owned by the assignee of the present invention, the contents of which are hereby incorporated by reference. It should be understood, however, that the present control valve can be used in other gas-assisted liquid droplet systems. This could include applications such as delivering medications transdermally by directing high speed droplets through the stratum corneum into the epidermis.

Still further, it should be understood that the control valve can be used in other applications where it is important to have a constant mass flow rate from a source of pressurized gas, such as air, or other gas, while the vessel is emptying.

A gas-assisted liquid droplet dentifrice system 10 is shown in FIG. 1. It includes a pressurized gas vessel 10, which has been pressurized from an external source to a desired pressure, for example 50 Bar. Other pressures could, of course, be used. One such vessel is made from stainless steel, with a length of 0.14 m, an internal volume of 55 cc, an outer diameter of 3 cm and a wall thickness of 3 mm. The exit opening 12 from the pressurized vessel is controlled by a shut-off valve 13. Downstream of shut-off valve 13 is a passive control valve 14, located at the front end of a brass duct 16 which has a diameter in the embodiment shown of 5 mm, and a length of 25 cm. At the exit of duct portion 16 is represented a droplet generator 18, such as shown and described in the above-referenced application. At this point, duct portion 16 narrows to duct portion 20 which has a diameter of approximately 0.5 mm. The droplets exit from duct portion 20 at a top member 21, accelerated by the air stream from valve 14 and are directed toward a target, such as the teeth of a user.

During release of gas from the pressurized vessel, the difference in pressure between that inside the vessel and the atmospheric pressure is large enough to produce gas exiting at the speed of sound in the smallest portion of the exit field. The mass flow of air through the above system is determined by the following formula:

$$\dot{m} = \frac{{ρ}_{o} {KA}_{c}}{\sqrt{{RT}_{o}}}$$

Where K is a constant, ρₒ is the pressure in the vessel, Tₒ is the temperature in the pressurized vessel,

R=R_{g}/Mₘ=287J·kg⁻¹·K⁻¹ (for air)

with R_{g} being the universal gas constant, Mₘ the molar mass of air, and A_{c} is the area of the smallest part of the valve, where the air velocity is equal to the speed of sound.

During the release of gas, the pressure in the vessel 12 will decrease from its initial value (50 bar in the above example) to approximately atmospheric pressure. In view of the above formula, under isothermal conditions, a valve with a value of constant open area Ac will result in a decreasing gas flow as the pressure in the vessel decreases. This results in a decrease in gas velocity in the system. Such a condition is also true for adiabatic conditions.

Valve 14 in FIG. 1 is shown in more detail in FIG. 2, and is a passive control valve which results in a constant mass flow over the time of release of gas from the vessel and corresponding decrease in pressure in vessel 10. In general, valve 14 is conical in exterior configuration, with a small peripheral lip 24 at the base of the valve which contacts and seals against the interior surface 25 of duct portion 16 (FIG. 1) leading from the pressurized tank. In the embodiment shown, for a vessel which is pressurized to 50 Bar, for example, a representative valve 14 is 11 mm long, with opening 26 through the valve having a diameter of 0.2 mm. The wall thickness of valve 14 increases from 6.7 mm at the end 28 proximal the pressurized vessel to approximately 10.6 mm at lip 24.

In the embodiment shown, valve 14 is made from rubber, although it could be made from other flexible, resilient materials, such as, for instance, other elastomeric materials. For a pressurized vessel of 50 Bar, the hardness of the rubber is 50 Shore A. The configuration and structure of a rubberized valve results in a substantially constant mass flow volume from a pressurized vessel of 50 Bar.

In operation, air will flow through opening 26 in valve 14 at a substantially constant rate; at the end of opening 26, the pressure will drop to a value close to atmospheric. Due to this pressure difference, rubber valve 14 will be initially deformed inwardly to some extent, resulting in a smaller local internal diameter. In the embodiment shown, the opening will be approximately 0.07 mm in diameter at the start. As the pressure in the vessel decreases, due to continuous exit of the gas, a reduction in the pressure difference occurs relative to atmospheric pressure This reduces the pressure on the control valve, letting it gradually open up to it's normal internal diameter. The rate of increase in the size of the opening in the valve shown for the pressurized vessel described is a sufficiently precise inverse function of the pressure remaining in the vessel, so that the mass flow of gas from the vessel remains constant during exit of the gas from the vessel.

The area A_{c} changes with the pressure in the vessel according to the formula: A_{c}∝Pₒ^{-α} For A_{c} to be a sufficiently precise inverse function of the pressure in the vessel, the value of inversion parameter α is preferably between 0.9 and 1.1, more preferably between 0.95 and 1.05, and most preferably between 0.98 and 1.02.

For a different pressurized vessel, with a different pressure, valve 14 could have a different length, shape and wall thickness, a different nominal opening diameter, and could comprise a different material, having a different hardness value. These factors are all adjusted to produce a constant mass flow over time for a particular pressurized vessel application. Again, for the particular vessel described above, the key consideration is the adjustment of the various physical characteristics of the control valve to correspond with the pressure so as to provide an inverse function of opening size v. pressure remaining in the vessel.

Another advantage of the rubberized passive control valve is that it dampens sound generated by the shock which results from the pressure decline from the value of pressure in the vessel to a pressure close to atmospheric conditions.

Accordingly, a passive pressure control valve has been shown and described which produces a constant mass flow for a pressurized vessel.

Although a preferred embodiment of the invention has been disclosed for purposes of illustration, it should be understood that various changes, modifications and substitutions may be incorporated in the embodiment without departing from the spirit of the invention which is defined by the claims which follow.

What is claimed is:

1. A passive control valve for use with a pressurized gas vessel, comprising: a control valve for controlling the release of gas from a pressurized vessel, the released gas then being used to accelerate liquid droplets, wherein the control valve comprises a rubberized material having an opening therethrough, allowing gas to escape in a controlled manner from the pressurized vessel, wherein the rubberized material has such a Shore hardness value and wherein the valve has such a configuration, relative to the size of the opening therethrough the valve and the pressure of the gas in the vessel, that the mass flow of gas from the vessel is approximately constant over time as gas exits from the vessel.

2. The control valve of claim 1, wherein the gas is air.

3. The control valve of claim 1, wherein the rubberized material is rubber.

4. The control valve of claim 1, wherein the cross sectional area of the opening through the valve changes over time, in a manner sufficiently inversely proportional to the change in pressure of the gas in the vessel that the flow of gas from the vessel is approximately constant.

5. The control valve of claim 4, wherein the inverse parameter of the change of area is between 0.9 and 1.1.

6. The control valve of claim 5, wherein the inverse parameter is between 0.98 and 1.02.

7. The control valve of claim 1, wherein the control valve is generally in the form of a truncated cone, with the opening extending through approximately the center thereof, and wherein the rubberized material has a Shore hardness of 50.

8. The control valve of claim 1, wherein the control valve and the pressurized vessel are part of a fluid droplet system for cleaning teeth.
